(19) United States
(12) Patent Application Publication
(10) Pub. No.: US 2007/0255969 A1
(43) Pub. Date: Nov. 1, 2007

(54) Device for Controlling the Energy Flow Between an Energy Supply Network and an Electric Device Connected Thereto

(76) Inventor: Holger Theobald, Hohen Neuendorf (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/659,574

(22) PCT Filed: Dec. 9, 2004
(86) PCT No.: PCT/EP04/14029

§ 371 Date: Feb. 7, 2007

(30) Foreign Application Priority Data
Aug. 11, 2004 (DE) 10 2004 039 810.0

(51) Int. Cl. G06F 1/26

(52) U.S. Cl. 713/320

(57) ABSTRACT

The invention relates to a device (1) for controlling the flow of energy between an electric energy supply network (70) and an electric device (2) connected thereto, in particular between a low voltage energy supply network and an electric consumer. The device (1) comprises a power element (22) which can be connected to the energy supply network (70) and the electric device (2), and a control part (24) which controls the power element (22) and which can be connected to a controller (14) by means of a control network (16). The device (1) also comprises, in the control network (16), a data address which is known by the controller (14) and control signals which are used to control the flow of energy from the control part can be captured by the control network (16) by using said data addresses. The invention is characterised in that the energy supply is dependent on the energy supply network (70) for the operation of the control part (24) of the device (1), and that the energy required for operating the control part (24) of the device (1) can be withdrawn from the control network (16).

The invention relates to a device for controlling the energy flow between an energy supply network and an electric device connected thereto, especially between a low voltage power supply network and an electrical consumer.

So-called house bus systems are known in which via a control network generic devices are triggered which devices are assigned to the individual electrical consumers in a household, for example a refrigerator, heating system, lights, or blinds. Basically data protocols matched to the respective application can be established. One example of this house bus system is the European Installation Bus EIB, with a bus protocol which has been established by the EIB Association.

The devices to be connected to the control network require a power supply for their operation. Generally this power is taken from a power supply network to which the consumer assigned to the device is also connected. If there is an interruption in the power supply, for example due to failure of the power supply network, the device cannot be operated via the control network. For many applications this does not constitute a problem, because the electrical consumers assigned to the devices are no longer supplied with power.

When the power supply is available again, all consumers are turned on more or less at the same time; in some cases this can lead to increased starting currents and thus to operation of fuses. This in turn can lead to failure of the power supply network. To prevent this, in the control center of the control network a sequence control system could be stored which runs after the power supply is available again and controls connection of the consumers. But this requires added control effort and is comparatively inflexible.

Therefore the object of the invention is to make available a generic device which overcomes the disadvantages of the prior art. In particular, control of the connected consumers should also be as individual and flexible as possible for the state following failure of the power supply network, mainly the behavior of the device and thus of the consumer after the power supply is available again can be determined with simple means.

This object is achieved by the device defined in claim 1. Special embodiments of the invention are defined in the dependent claims.

The object is achieved in that the power supply especially of the control part of the device is independent of the power supply of the electrical means which is connected to the device, and that the power necessary for operation of the control part of the device can be taken from the control network. This is associated not only with the advantage that operation of the device is not dependent on whether the power supply network is intact or not; this alone could also be brought about by an electrochemical energy storage mechanism such as a battery. This would require regular replacement of the battery and thus expenditures. Moreover the use of electrochemical energy storage mechanisms in several explosive areas is not allowed; these energy storage mechanisms are subject to ageing processes and fundamentally have limited capacity.

It is furthermore rather advantageous that even for a long-lasting failure or shutdown of the power supply network the device can be accessed by control engineering without being dependent on the charging state of a local energy storage mechanism. The imminent failure of the power supply network can be promptly detected by the device based on corresponding test criteria, which link to amplitude, frequency and/or phase response, and the shutoff process of especially critical electrical means can be initiated early and mainly rule-based.

When the power supply is available again the device can turn on the connected electrical means rule-based in succession in order in this way for example to ensure the required sequence of individual electrical means.

This is especially advantageous in data processing devices, in which for example before a computer is turned on the peripheral must be turned on so that the computer recognizes the peripheral properly as it starts up.

Data processing devices, such as for example personal computers, are often networked to one another via a data network. Data are exchanged over the data network according to a standardized protocol, for example according to the Ethernet protocol. In many applications the data networks are built hierarchically with one or more network nodes, to which so-called client computers are connected which are ordinarily workstation computers, or so-called server computers, which generally have higher performance than client computers.

In many applications the client computers are located spatially apart from one another, for example in different rooms of a building, in different buildings at one location and/or also at different locations. In particular, in a business environment data processing devices are potentially located several hundred or even several thousand kilometers apart from one another.

Not only in data processing devices but generally in electrical means, especially for reasons of saving energy or also for protection of devices, for example against a lightning stroke the power supply network or other overvoltage, it can be desirable to separate the electrical means from the power supply network outside of definable times of day, during non-peak operation, absence due to vacation, or event-dictated.

The control network via which the device receives control signals from the controller can be structured like a conventional data network with respect to the protocol and/or the topography. An interface unit which forms the interface to the control network in the device forms a type of client within the control network. The interface unit and other components of the device can be located for example on a board of the device. Preferably the device is located in a housing which is separate from the electrical means.

Preferably the device in the control network has a unique data address issued only once. The electrical means which can be connected to the device can also have a unique data address issued preferably only once in the control network so that it is also known to the controller which electrical means is being supplied with power, controlled by the device. The addresses of the device and/or of the electrical means can be structured such that grouped assignment of the connectable electrical means is possible, for example assignment to the type of computer, printer, monitor, etc. In this way for example monitors or printers can be separated from the power supply outside of definable operating times, while the pertinent computers continue to be supplied with power, for example in order to update the application programs stored on the computer within the framework of a network-wide update at night.

This can also be used for a higher order system to which several devices as claimed in the invention are connected and in turn control the power flow of a plurality of electrical means. Certain electrical means can be turned off in groups, for example the outlets in kitchens within a building, even if they are connected to different devices. The corresponding control signals are supplied to the devices via the control network.

In one special embodiment of the invention the device has an energy storage mechanism which can be charged via the control network and/or via the power supply network, and which can be discharged to meet a power demand of the device which temporarily exceeds the amount of power which can be made available by the control network. This is especially advantageous when a briefly very high power demand arises when an actuating element or switching element of the device and/or the pertinent switching processes are triggered. Also unwanted effects of these switching processes on the control network can be prevented by the local energy storage mechanism of the device.

The energy storage mechanism can also be an electrochemical energy storage mechanism; but preferably those energy storage mechanisms are used, especially electrostatic energy storage mechanisms, which are not subject to noticeable ageing processes and/or which have low internal resistance.

In one special embodiment the power part of the device has an energy storage mechanism which can be charged via the power supply network and which can be discharged to meet the power demands for operation of an actuating element for controlling the power flow between the power supply network and the electrical means. This is especially advantageous when the power of the actuating element is considerable. Control of the power flow in this case is even possible when the power supply network is no longer available or no longer available without restrictions.

In one special embodiment the device has at least one receptacle for a plug connection to a power supply line of the electrical means. The receptacle can be for example an outlet which is conventional according to the respective national standards for a low voltage power supply line. Low voltage is defined here as the conventional supply voltage of the electrical means, that is, for example 110 V, 230 V, or 380 V. For this reason no modification of the electrical means is necessary, but the device as claimed in the invention is connected simply between the electrical means and the low voltage power supply network.

In one special embodiment the device has an actuating element, especially a switching element, by means of which the power flow between the power supply network and the electrical means can be interrupted and re-established according to control signals which have been received via the control network. Interruption takes place in this regard preferably on all phases of the power supply line. Preferably interruption takes place by complete DC-decoupling, for example by means of an electromagnetically actuated switch such as a relay. In addition there can be a fuse, especially series-connected with DC decoupling, for example a fusible link or a resettable electronic fuse against an overcurrent or overvoltage. In this way the electrical means is reliably protected against overvoltages which can occur in the power supply network for example as a result of a lightning stroke. Moreover the power consumption of the connected electrical means is reduced again relative to stand-by operation.

In one special embodiment the power supply of several electrical means can be controlled from the device. For this purpose the device preferably has one power part for each connectable electrical means, for example for each receptacle, by means of which power part the power supply of the connectable electrical means can be individually controlled. In this way for example in a workstation with a computer, a monitor and a printer which are connected to a common device, at night the monitor and printer can be completely separated from the power supply, while the computer continues to be supplied with power, so that maintenance and software updating can be carried out over a parallel data network. Analogously the outlet for a an iron for example can be turned off during a vacation, while the freezer continues in operation.

In this connection the several power parts can each be triggered by an individually assigned control part, or groups of power parts or even all power parts of the device can be triggered by a single control part.

In one special embodiment the device has overvoltage protection for the connectable electrical means. In this way damage to the connected electrical means can be prevented even in the operating state in which the power supply is switched through to the electrical means. Overvoltage protection can be implemented for example by voltage-dependent resistors which undergo transition into a low-resistance state in an overvoltage and thus divert the overvoltages.

In one special embodiment the device has an uninterrupted power supply for the connectable electrical means. Depending on the dimensioning of the uninterrupted power supply and the power consumption of the connected electrical means, interruptions in the power supply in the range of a few seconds to a few dozen minutes or even hours and days can be buffered. If the device as claimed in the invention is also connected via a data line to the connected electrical means, when an interruption of the power supply occurs the electrical means can moreover be transferred into a safe operating state, for example into stand-by operation, or can be shut down in a controlled manner and then turned off. This applies especially to data system electrical means and electrical means with electric motor drive.

In one special embodiment of the invention several connected electrical means can be turned on again according to definable rules after the power supply is ensured again, in particular the power supply can be switched through again to the electrical means controlled by the controller by means of the device as claimed in the invention. The definable rules can for example ensure that a first electrical means is supplied with power again before a-second electrical means, for example a computer is started up.

In one special embodiment the device has a measuring device for at least qualitative measurement of the power flow via the device into the electrical means. An only qualitative measurement can comprise for example classification of the operating state of the connected electrical means into “off”, “stand-by” and “in operation”. The measured power flow can be transmitted from the device via the control network to the controller. In this way, for the controller the information is present regarding which of the electrical means connected to the devices are in operation or in the stand-by mode. The corresponding information can also be logged and optionally relayed to an administrator. In this way unauthorized operation of the electrical means can also be determined, when for example power consumption on a connected electrical means is recorded outside the operating time or absence due to vacation. Via the device as claimed in the invention it is moreover possible to separate the pertinent means from the power supply, controlled by the controller.

In one special embodiment the device has a manually actuated control element, upon actuation of which the connected electrical means is supplied with power, regardless of the control signals received from the controller. In this way for example in urgent cases an electrical means can be accessed even if the controller has stipulated separation of the power supply. The control element in the simplest case can be a button. There can also be additional security measures so that the control element can only be actuated by an individual authorized to do so, for example the control element can require the input of a code or password, by means of which the actuating individual is authorized for a corresponding action.

Preferably the control network is DC-decoupled and/or independent of the power supply of the electrical means, the energy storage mechanism of the interrupt-free power supply of the device as claimed in the invention however being able to be supplied from the power supply of the electrical means. Even with DC-decoupling, feed of the control network by the power supply of the electrical means is possible, for example by contactless transmission of power by electromagnetic coupling.

Preferably the control part of the device is DC-decoupled from the power part, in one embodiment there is no resistive or electrically conductive connection between the control part and the power part. Signal coupling between the control part and the power part is possible via capacitive, inductive or optical couplers, or also via a relay or the like.

Other advantages, features and details of the invention will become apparent from the dependent claims and the following description in which several embodiments are described in particular with reference to the drawings. In this connection the features mentioned in the claims and in the specification can be essential for the invention singly or in any combination with one another.

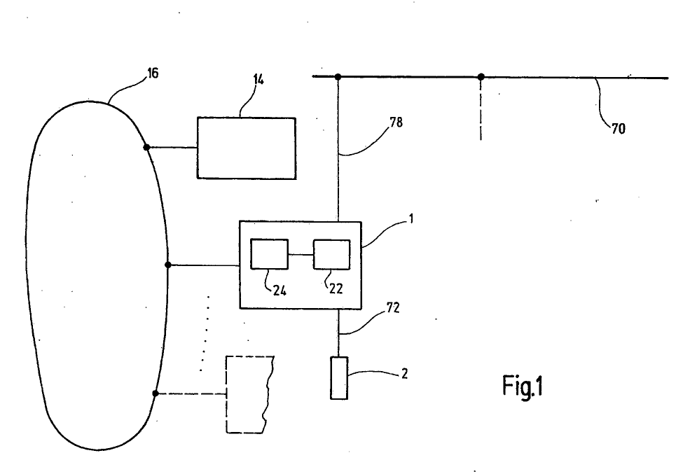

FIG. 1 shows the device as claimed in the invention,

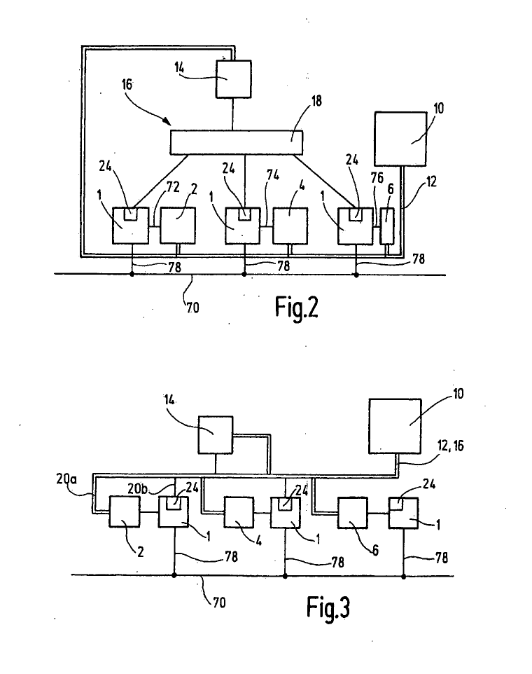

FIG. 2 shows an alternative configuration with several devices as claimed in the invention,

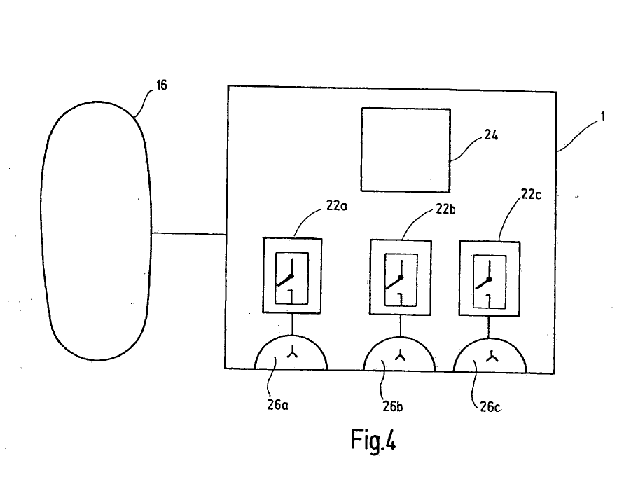

FIG. 3 shows another possible configuration of the devices as claimed in the invention,

FIG. 4 shows another device as claimed in the invention, and

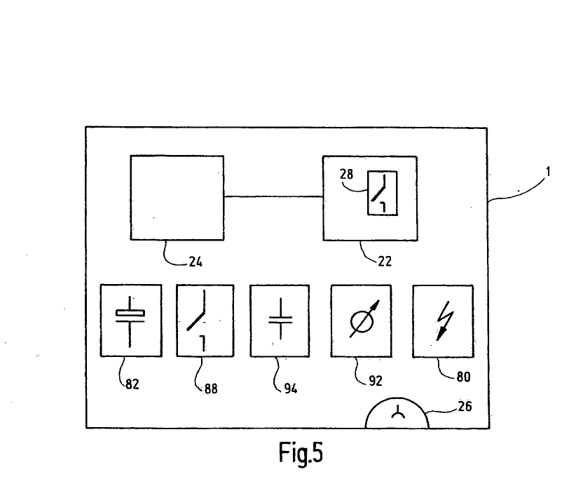

FIG. 5 shows a more detailed representation of the device as claimed in the invention.

FIG. 1 shows a device 1 as claimed in the invention for controlling the power flow between an electrical power supply network 70 and an electrical means 2 connected thereto, especially between a low voltage power supply network and an electrical consumer. The device 1 has a power part 22 which is connected to the power supply network 70 over a connecting line 78 and which is moreover connected to the electrical means 2 over a power supply line 72. Furthermore the device 1 has a control part 24 which controls the power part 22 and which can be connected to a controller 14 via a control network 16. The device 1 in the control network 16 has a data address which is known to the controller 14 and the control part 24 using this data address receives control signals over the control network 16 to control the power flow. Conversely the device 1 can send data to the controller 14 over the control network 16, for example relating to the status of the connected electrical means 2 or confirmation for the control signals received.

The power supply line 72 can be a conventional power supply cable of the electrical means 2 which can be plugged into the corresponding receptacle or outlet on the device 1. The device 1 is connected to the power supply network 70 which is a two-phase or three-phase low voltage supply network via the connecting line 78.

The power supply for operation of the control part 24 of the device 1 is independent of the power supply network 70, in particular the power required for operation of the control part 24 of the device is taken from the control network 16. As is shown in FIG. 1 by the broken line, other devices as claimed in the invention which receive their control signals from the controller 14 and which are likewise connected to the power supply network 70 via a connecting line can be connected to the control network 16.

FIG. 2 shows a configuration in which several devices 1 are connected via the data network 12 with bus topology to one another and to the server 10 and the controller 14. The topology of the control network 16 via which the controller 14 is connected to the devices 1 is conversely star-shaped, an active distributor 18, for example a so-called hub or switch, being connected between the controller 14 and the devices 1. The power supply of the devices 1 takes place via the control network 16. Both the data network 12 and also the control network 16 can also have a ring topology.

In the illustrated embodiment each of the two other devices 1 are connected via a power supply line 74, 76 to electrical means 4, 6 which are data engineering system devices such as a monitor and a printer. The other devices 1 are also connected to the control network 16 and to the controller 14. The controller 14 can send control signals over the control network 16 to the devices 1, for example such that the devices 1 interrupt the power supply of the electrical means 2, 4, 6, interruption taking place preferably completely with DC-decoupling, for example by using a relay.

The controller 14 can operate the electrical means 2, 4, 6 individually via the pertinent device 1 as claimed in the invention and the data addresses assigned to these devices 1, the pertinent control preferably enabling grouped triggering of the pertinent devices 1 and therefore it not being necessary to input the individual addresses of the devices 1 assigned to the electrical means 2, 4, 6 which are to be shut off or to identify them individually in some other way.

The electrical means 2, 4, 6 are moreover connected to a data network 12, to which the controller 14 is also connected. Furthermore a server computer 10 is connected to the data network 12 and can also assume control of the controller 14. In particular, it is possible for the server computer 10 via the data network 12 to send to the controller 14 the instruction to separate one, several or all electrical means 2, 4, 6 from the power supply. This can take place for example by corresponding administration software or by an operator who is provided with administrator rights and who logs in into the data network 12 on the server computer 10 or on one of the client computers with administrator rights.

FIG. 3 shows another possible configuration of the devices 1 as claimed in the invention, in this embodiment the data network 12 and the control network 16 being integrated in a common network, so that separate wiring for the control network 16 is not necessary. The common network 12, 16 is implemented with bus topology, the electrical means 2, 4, 6 being linearly connected over a common cable which forms the bus. The cable can be divided for this purpose at the respective electrical means 2, 4, 6 and at the controller 14 and a first connecting line 20a can be supplied to the existing network card of the electrical means 2, while a second connecting line 20b is supplied to the device 1 as claimed in the invention. Both connecting lines 20a, 20b can be provided with their own connecting elements, for example plugs.

FIGS. 1 to 3 show embodiments with network topologies executed in pure form. As claimed in the invention, especially for the control network 16 a mixed form of ring topology, star topology and bus topology can also be used.

FIG. 4 shows a device 1 as claimed in the invention which has a total of three power parts 22a, 22b, 22c which for their part each control the power flow between the power supply network 70 and an outlet 26a, 26b, 26c which has been assigned individually to the respective power part 22a, 22b, 22c. All three power parts 22a, 22b, 22c are controlled by a common control part 24 of the device 1 which is connected to the control network 16. The selection of outlets 26a, 26b, 26c is done according to the control signals which have been sent from the controller 14 and received by the control part 24.

In this connection, the control signal of the controller 14 can directly determine the outlet 26a, 26b, 26c to be connected, for example by the pertinent unique address which is issued only once within the device 1 in any case. Alternatively or in addition, the control signal of the controller 14 of the outlet 26a, 26b, 26c to be connected can also only be indirectly determined, for example can stipulate that all printers are to be shut off. The device 1 in this instance has the control intelligence to recognize to which outlet 26a, 26b, 26c the printers are connected, or this is invariably fixed, whereupon the device 1 shuts off the corresponding outlet 26a, 26b, 26c.

FIG. 5 shows a more detailed representation of the device 1 as claimed in the invention. The device 1 is connected to the controller 24 via the control network 16 by means of the control part 24. Data exchange takes place bidirectionally, i.e., control data can be both received from the controller 14 and also data can be transmitted from the device 1 to the controller 14.

The device 1 moreover has an energy storage mechanism 94, in this embodiment an electrostatic storage mechanism in the form of a capacitor. This energy storage mechanism 94 is charged preferably via the control network 16 to a comparatively low charging current, and releases its energy mainly in switching processes of the device 1, the discharge current generally being larger than the charging current.

The device 1 has overvoltage protection 80 and an uninterrupted power supply 82. When a power failure occurs, the uninterrupted power supply 82 can send a trigger signal via a data line, which is not shown, to the electrical means 2, so that it is transferred into a safe operating state, for example a data systems engineering device is shut down and turned off to prevent loss of data. The uninterrupted power supply 82 can furthermore make available the power necessary for shifting the electrical means 2 into a safe operating state.

From outside the device 1 a switching element 88 can be manually actuated, for example a button or a switch, by means of which the socket 24 and thus the electrical means 2 connected to it are supplied with power or are separated from the power supply network 70, regardless of the control signals sent from the controller 14 via the control network 16 to the control part 24 and the state of the power part 22. For this purpose essentially one switching element 88 can be connected electrically parallel to the power part 22, especially to an actuating element 28 or switching element of the power part 22, and/or another switching element can be electrically connected in series to the power part 22.

The device 1 furthermore has a measuring device 92 by which the power flow from the power supply network 70 via the device 1 to the electrical means 2 can be at least qualitatively measured. In particular, the measuring device 92 can distinguish whether the electrical means 2 has been completely turned off, is in the stand-by mode or is in operation. Alternatively or in addition, the measuring device 92 can also quantitatively measure the power consumption of the electrical means 2. For this purpose there can also be sensors in the device 1 or sensors can be connected to it. The output signal of the measuring device 92 can be sent to the controller 14 via the control part 24 and the network 16. For an administrator therefore it can also be determined at a remote location whether the electrical means 2 is properly in operation, is in the stand-by model or has been completely turned off. By accurately determining the power consumption of the electrical means 2 and sending the measured value to the controller 14, moreover remote monitoring or even remote diagnosis relating to the electrical means 2 can be done, for example in the event power consumption occurs which is increased or reduced relative to the nominal value.

In addition to the sensors for measurement of the power flow, also other physical quantities can be detected by sensors by the device 1, especially temperature, smoke development, humidity, sound and the like. Sensor signals in this respect can also be transmitted via the control network 16 to the controller 14 and when definable boundary values are exceeded trigger an alarm. The measured values of the sensors can also be stored only in the device 1, and retrieved via the control network 16.

1. A device (1) for controlling the energy flow between an energy supply network (70) and an electric device (2) connected thereto, especially between a low voltage power supply network and an electrical consumer, the device (1) having a power part (22) which can be connected to the power supply network (70) and the electrical means (2) and having a control part (24) which controls the power part (22) and which can be connected to the controller (14) via a control network (16), and the device (1) in the control network (16) having a data address known to the controller (14) and using this data address, control signals for controlling the power flow from the control part (24) can be received over the control network (16), characterized in that the power supply for operation of the control part (24) of the device (1) is independent of the power supply network (70) and that the power required for operation of the control part (24) of the device (1) can be taken from the control network (16).

2. The device (1) as claimed in claim 1, wherein the device (1) has an energy storage mechanism (94) which can be charged via the control network (16) and/or via the power supply network (70), and which can be discharged to meet a power demand of the device (1) which temporarily exceeds the amount of power which can be made available by the control network (16).

3. The device (1) as claimed in claim 1, wherein the power part (22) of the device (1) has an energy storage mechanism (94) which can be charged via the power supply network (70) and which can be discharged to meet the power demand for operation of an actuating element (28) for controlling the power flow between the power supply network (70) and the electrical means (2).

4. The device (1) as claimed in claim 1, wherein there is DC-decoupling between the control part (24) and the power part (22).

5. The device (1) as claimed in claim 1, wherein the device (1) has an actuating element (28), especially a switching element, by means of which the power flow between the power supply network (70) and the electrical means (2) can be interrupted and re-established according to control signals received via the control network (16).

6. The device (1) as claimed in claim 1, wherein the power flow between the power supply network (70) and several electrical means (2, 4, 6) can be controlled by the device (1), and wherein the device (1) for each connectable electrical means (2, 4 6) has a power part (22a, 22b, 22c) by means of which the power flow can be individually controlled.

7. The device (1) as claimed in claim 1, wherein the device (1) has overvoltage protection (80) for the connectable electrical means (2).

8. The device (1) as claimed in claim 1, wherein the device (1) has an uninterrupted power supply (82) for the connectable electrical means (2).

9. The device (1) as claimed in claim 1, wherein the device (1) has a measuring device (92) for at least qualitative measurement of the power flow between the power supply network (70) and the electrical means (2).

10. The device (1) as claimed in claim 9, wherein the measured power flow can be transmitted from the device (1) via the control network (16) to the controller (14).

11. The device (1) as claimed in claim 1, wherein the device (1) has a manually actuated control element (88), upon actuation of which the connected electrical means (2) can be connected to the power supply network (70) and/or can be separated from the power supply network (70), regardless of the control signals received from the controller (14).

12. The device (1) as claimed in claim 1, wherein the device (1) has at least one receptacle for a plug connection to the electrical means (2), especially an outlet (26) for the low voltage power supply network.
